(19) United States
(12) Patent Application Publication
(10) Pub. No.: US 2022/0174258 A1
(43) Pub. Date: Jun. 2, 2022

(54) INFORMATION PROCESSING DEVICE, INFORMATION PROCESSING METHOD, AND PROGRAM

(71) Applicant: SONY GROUP CORPORATION, TOKYO (JP)

(72) Inventors: KOJI NISHIDA, TOKYO (JP); SHUICHI TAKAHASHI, TOKYO (JP); DAISUKE IRIE, TOKYO (JP)

(21) Appl. No.: 17/436,447

(22) PCT Filed: Mar. 4, 2020
(86) PCT No.: PCT/JP2020/009038

§ 371 Date: Sep. 3, 2021

(30) Foreign Application Priority Data
Mar. 13, 2019 (JP) 2019-046114

(51) Int. Cl. H04N 13/282; H04N 13/279; H04N 13/344

(52) U.S. Cl. CPC H04N 13/282; H04N 13/344; H04N 13/279

(57) ABSTRACT

An information processing device to be provided includes: a viewpoint information acquisition unit that acquires information regarding the viewpoint from which a first video image has been captured; a related information acquisition unit that acquires related information about the first video image; and a generation unit that generates a second video image using the information regarding the viewpoint and the related information, the second video image being associated with the first video image and being interlocked with the first video image.

### TECHNICAL FIELD

The present disclosure relates to an information processing device, an information processing method, and a program.

### BACKGROUND ART

In recent years, technologies for displaying a certain video image (a first video image) and another video image (a second video image) related to the video image have been developed. For example, Non-Patent Document 1 mentioned below discloses a technology for enhancing a sense of immersion by projecting a video image (the second video image) onto regions outside the display of a television set, the video image supplementing a video image (the first video image) of a game being displayed on the display of the television set.

### CITATION LIST

### Non-Patent Document

Non-Patent Document 1: Andy Wilson, and one other, “IllumiRoom: Peripheral Projected Illusions for Interactive Experiences”, [online], Jan. 4, 2013, Microsoft, [searched on Feb. 15, 2019], Internet <URL: https://www.microsoft.com/en-us/research/project/illumiroom-peripheral-projected-illusions-for-interactive-experiences/>

### SUMMARY OF THE INVENTION

### Problems to be Solved by the Invention

However, by the technology and the like described above, the second video image associated with the first video image cannot be appropriately generated in some cases. For example, in the technology disclosed in Non-Patent Document 1, the contents of the first video image to be displayed should be determined beforehand, and therefore, the second video image cannot be appropriately generated when the contents of the first video image have not been determined beforehand, as when a video image captured from a certain viewpoint is distributed (such as a live sporting event, for example) (note that this is a specific example of a case where the second video image cannot be appropriately generated, and the problems to be solved by the present disclosure are not limited to this problem).

Therefore, the present disclosure is made in view of the above circumstances, and provides an information processing device, an information processing method, and a program that are novel and improved, and are capable of more appropriately generating a second video image associated with a first video image.

### Solutions to Problems

The present disclosure provides an information processing device that includes: a viewpoint information acquisition unit that acquires information regarding the viewpoint from which a first video image has been captured; a related information acquisition unit that acquires related information about the first video image; and a generation unit that generates a second video image using the information regarding the viewpoint and the related information, the second video image being associated with the first video image and being interlocked with the first video image.

The present disclosure also provides an information processing method implemented by a computer, the information processing method including: acquiring information regarding the viewpoint from which a first video image has been captured; acquiring related information about the first video image; and generating a second video image using the information regarding the viewpoint and the related information, the second video image being associated with the first video image and being interlocked with the first video image.

The present disclosure also provides a program for causing a computer to: acquire information regarding the viewpoint from which a first video image has been captured; acquire related information about the first video image; and generate a second video image using the information regarding the viewpoint and the related information, the second video image being associated with the first video image and being interlocked with the first video image.

### BRIEF DESCRIPTION OF DRAWINGS

FIG. 1 is a diagram showing an outline of a first embodiment.

FIG. 2 is a block diagram showing an example configuration of an information processing system according to the first embodiment.

FIG. 3 is a block diagram showing the information processing device according to the first embodiment.

FIG. 4 is a flowchart showing an example process flow in the information processing device according to the first embodiment.

FIG. 5 is a flowchart showing the example process flow in the information processing device according to the first embodiment.

FIG. 6 is a flowchart showing an example process flow in an information processing device according to a second embodiment.

FIG. 7 is a flowchart showing the example process flow in the information processing device according to the second embodiment.

FIG. 8 is a block diagram showing an example configuration of an information processing system according to a third embodiment.

FIG. 9 is a block diagram showing an example configuration of an information processing device according to the third embodiment.

FIG. 10 is a flowchart showing an example process flow in the information processing device according to the third embodiment.

FIG. 11 is a flowchart showing the example process flow in the information processing device according to the third embodiment.

FIG. 12 is a diagram for explaining a method for determining the sizes and the shapes of a first video image and a second video image in a composite video image.

FIG. 13 is a diagram for explaining a method for determining the sizes and the shapes of a first video image and a second video image in a composite video image.

FIG. 14 is a diagram for explaining a method for determining the sizes and the shapes of a first video image and a second video image in a composite video image.

FIG. 15 is a diagram for explaining a method for determining the sizes and the shapes of a first video image and a second video image in a composite video image.

FIG. 16 is a block diagram showing an example configuration of an information processing device according to a fourth embodiment.

FIG. 17 is a flowchart showing an example process flow in the information processing device according to the fourth embodiment.

FIG. 18 is a flowchart showing the example process flow in the information processing device according to the fourth embodiment.

FIG. 19 is a block diagram showing an example configuration of an information processing device according to a fifth embodiment.

FIG. 20 is a flowchart showing an example process flow in the information processing device according to the fifth embodiment.

FIG. 21 is a flowchart showing the example process flow in the information processing device according to the fifth embodiment.

FIG. 22 is a block diagram showing an example configuration of an information processing system according to a sixth embodiment.

FIG. 23 is a block diagram showing an example configuration of an information processing device according to the sixth embodiment.

FIG. 24 is a flowchart showing an example process flow in the information processing device according to the sixth embodiment.

FIG. 25 is a flowchart showing the example process flow in the information processing device according to the sixth embodiment.

FIG. 26 is a diagram for explaining the measures to be taken when a second video image does not fit in the displayable region of the second video display device.

FIG. 27 is a block diagram showing an example hardware configuration of an information processing device according to each embodiment.

### MODES FOR CARRYING OUT THE INVENTION

The following is a detailed description of preferred embodiments of the present disclosure, with reference to the accompanying drawings. Note that, in this specification and the drawings, components having substantially the same functional configurations are denoted by the same reference numerals, and explanation of them will not be repeated.

Note that explanation will be made in the following order.

1. First Embodiment

2. Second Embodiment

3. Third Embodiment

4. Fourth Embodiment

5. Fifth Embodiment

6. Sixth Embodiment

7. Remarks

8. Example hardware configuration

### 1. First Embodiment

First, a first embodiment according to the present disclosure is described.

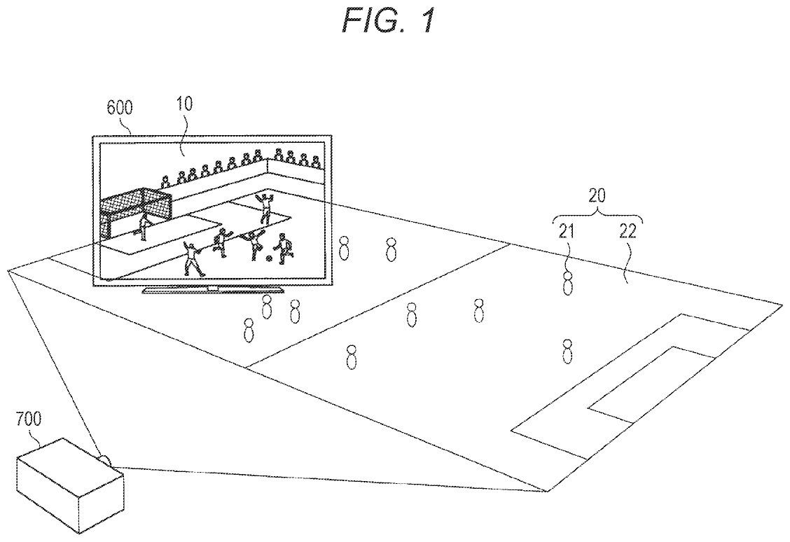

FIG. 1 is a diagram showing an outline of the first embodiment of the present disclosure. As shown in FIG. 1, an information processing system according to the first embodiment includes a first video display device 600 that displays a first video image 10, and a second video display device 700 that displays a second video image 20 that is related to the first video image 10 and is interlocked with first video image 10.

In the example in FIG. 1, the first video display device 600 is a television set, and displays a video image of a soccer match as the first video image 10. Meanwhile, the second video display device 700 is a projector, and projects a video image missing from the first video image 10 as the second video image 20 toward the display of the television set displaying the first video image 10 (in other words, the first video image 10 and the second video image 20 complement each other with missing information). More specifically, the second video display device 700 projects a video image 21 corresponding to a player included in the region missing from the first video image 10, a video image 22 corresponding to the ground, and the like. Further, as shown in FIG. 1, the first video image 10 and the second video image 20 complement each other with information about the white lines on the ground (in other words, the first video image 10 or the second video image 20 includes at least part of the frame (the white lines on the ground) that is determined depending on the captured target in the first video image 10).

Here, the second video image 20 may be displayed in the region in which the first video image 10 is not displayed, or may be displayed so as to be superimposed on the first video image 10. For example, the second video image 20 indicating information that is not displayed in the first video image 10, such as the players' names, may be displayed so as to be superimposed on the first video image 10. The second video image 20 is also projected, having been transformed into a video image seen from the viewpoint from which the first video image 10 was captured (that is, the viewpoints of the first video image 10 and the second video image 20 are the same).

With this arrangement, even if the viewpoint (camera angle) from which the first video image 10 was captured is not changed, the viewer can intuitively recognize the information outside the field of view of the camera in real time. Accordingly, even when the first video image 10 is an enlarged video image of an object, for example, the viewer can intuitively recognize the location of the object in the venue (the location of a player on the ground, for example), the situation of the entire venue, and the like. Further, the information processing system according to this embodiment can make the first video image 10 and the second video image 20 appear to be joined to each other by the process described above, and thus, can give the viewer the impression that the display screen has become larger.

Note that FIG. 1 is a diagram showing only the outline of this embodiment, and the contents of this embodiment are not necessarily limited to the example shown FIG. 1. In the description below, this embodiment will be described in detail.

(1.1. Example Configuration)

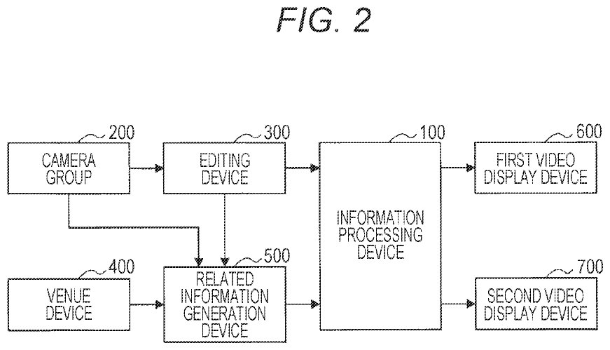

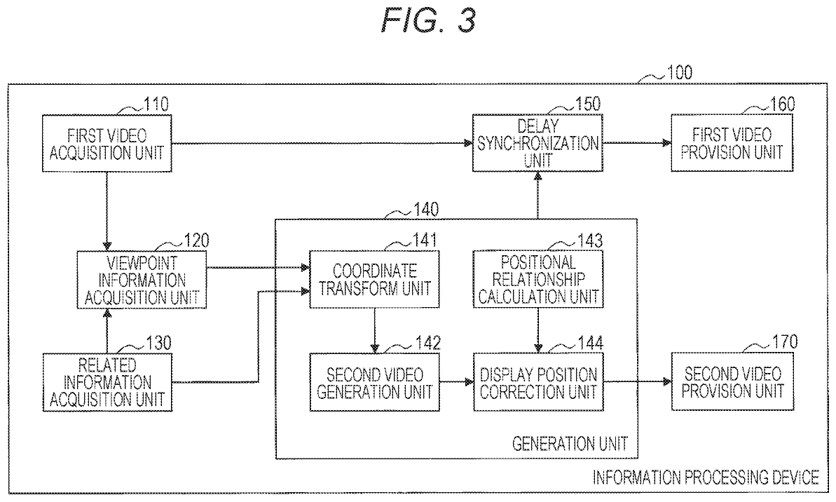

The outline of the first embodiment has been described above. Referring now to FIGS. 2 and 3, an example configuration according to the first embodiment is described.

FIG. 2 is a block diagram showing an example configuration of the information processing system according to the first embodiment. As shown in FIG. 2, the information processing system according to the first embodiment includes an information processing device 100, a camera group 200, an editing device 300, a venue device 400, a related information generation device 500, the first video display device 600, and the second video display device 700.

The camera group 200 is a device such as a video camera or two or more video cameras that capture the first video image 10. More specifically, the camera group 200 includes a video camera or the like disposed at a location or two or more locations in the venue (such as a soccer stadium, for example). The camera group 200 sequentially provides each frame of the generated first video image 10 to the editing device 300 and the related information generation device 500. Note that the type and the number of the devices (video cameras and the like) that constitute the camera group 200 are not limited to any particular ones.

The editing device 300 is a device that selects a video image captured by a plurality of video cameras in the camera group 200 as needed. The video selecting method is not limited to any particular method. For example, a video image can be selected by an input from a video distributor or the like. The editing device 300 provides each frame of the selected video image to the information processing device 100 and the related information generation device 500. Note that the editing device 300 may perform various kinds of image processing. Further, the type and the number of editing devices 300 are not limited to any particular type and number. Alternatively, the editing device 300 may be formed with a device having a video function and a device having a relay function. Further, the method for providing the first video image 10 to the information processing device 100 is not limited to any particular method. For example, the first video image 10 may be provided to the information processing device 100 via an appropriate communication line including a broadcast network used for television broadcasting or the Internet. Alternatively, the first video image 10 may be recorded in an appropriate recording medium, and the recording medium may be connected to the information processing device 100, so that the first video image 10 can be provided to the information processing device 100.

The venue device 400 is a device that acquires information to be used for generating related information about the first video image 10. Here, the “related information” is only required to be information related to the first video image 10. For example, the related information includes information regarding the venue that can appear as an object in the first video image 10 (such as the shape of the ground, the shape of the stadium, or the locations of video cameras placed in the stadium in the example of a soccer match live), information regarding people (such as the players' names, locations, postures, physiques, face images, uniform numbers, and positions, or biological information such as heart rates, in the example of a soccer match live), information regarding objects (such as the location and spin amount of the soccer ball, or the locations of the goalposts, in the example of a soccer match live), or information regarding results of analysis of these pieces of information (such as the location of an offside line, the track of movement of a player or the ball, or a result of prediction of movement, in the example of a soccer match live), and is not necessarily limited to these pieces of information. It goes without saying that the related information changes on the basis of the contents of the first video image 10. For example, if the contents of the first video image 10 are a concert or a play, the information related to the venue included in the related information may be the shape of the stage (platform stage) or the like, the information related to people may be the performers' names, locations, postures, physiques, face images, costumes, role names, dialogues, music scores, and lyrics, or biological information such as heart rates, the information related to objects may be the positions of settings or the like, and the information related to results of analysis of these pieces of information may be the progress status or the like of the concert or the play. Note that the contents of the related information are not necessarily limited to the above. For example, the related information may be identification information or the like about a video camera selected by the editing device 300. The venue device 400 is a sensor or two or more sensors (such as a location sensor, an acceleration sensor, a gyroscope sensor, or an image sensor, for example) provided in a venue, on a person, on an object, or the like. The venue device 400 acquires sensor data to be used for generating the related information described above, and provides the sensor data to the related information generation device 500. Note that the type and the number of the venue devices 400 are not limited to any particular type and number.

The related information generation device 500 is a device that generates the related information. More specifically, the related information generation device 500 generates the related information by analyzing the information provided from the camera group 200, the editing device 300, and the venue device 400. For example, when the first video image 10 is provided from the camera group 200, or where the first video image 10 selected by the editing device 300 is provided, the related information generation device 500 generates the related information described above, by analyzing the first video image 10. Further, when sensor data is provided from the venue device 400, the related information generation device 500 generates the related information by analyzing the sensor data. The related information generation device 500 then provides the generated related information to the information processing device 100. Note that the type and the number of the related information generation devices 500 are not limited to any particular type and number. Further, part of the related information may be provided separately to the related information generation device 500, not through analysis of the first video image 10 or the sensor data. For example, the known related information such as the shape of the stadium may be separately provided to the related information generation device 500 through an input from a video distributor or the like. Also, the related information generated by the related information generation device 500 is preferably synchronized with the frames of the first video image 10, but may not necessarily be synchronized with the frames of the first video image 10. Further, the method for providing the related information to the information processing device 100 is not limited to any particular method. For example, the related information may be provided to the information processing device 100 via an appropriate communication line including a broadcast network used for television broadcasting or the Internet. Alternatively, the related information may be recorded in an appropriate recording medium, and the recording medium may be connected to the information processing device 100, so that the related information can be provided to the information processing device 100.

The information processing device 100 is a device that generates the second video image 20, using the first video image 10 and the related information. An example configuration of the information processing device 100 will be described later in detail. The information processing device 100 provides the first video image 10 to the first video display device 600, and the second video image 20 to the second video display device 700. Note that the information processing device 100 can be formed with a personal computer (PC), a smartphone, or the like of the viewer. However, the information processing device 100 is not necessarily limited to these devices, and the number of them is not limited to any particular number.

The first video display device 600 is a device that displays the first video image 10. For example, as shown in FIG. 1, the first video display device 600 may be a television set. However, the first video display device 600 is not necessarily limited to this example. More specifically, the first video display device 600 includes a device equipped with a stationary display capable of displaying the first video image 10 (such as a PC, for example), or a device capable of projecting the first video image 10 (such as a projector, for example). Further, the number of the first video display devices 600 is not limited to any particular number.

The second video display device 700 is a device that displays the second video image 20. For example, as shown in FIG. 1, the second video display device 700 may be a projector. However, like the first video display device 600, the second video display device 700 is not necessarily limited to this example. Further, the number of the second video display devices 700 is not limited to any particular number.

An example configuration of the information processing system according to this embodiment has been described so far. Note that the configuration described above with reference to FIG. 2 is merely an example, and the configuration of the information processing system according to this embodiment is not limited to such an example. The configuration of the information processing system according to this embodiment can be flexibly modified depending on specifications and operations.

FIG. 3 is a block diagram showing the information processing device 100 according to the first embodiment. As shown in FIG. 3, the information processing device 100 includes a first video acquisition unit 110, a viewpoint information acquisition unit 120, a related information acquisition unit 130, a generation unit 140, a delay synchronization unit 150, a first video provision unit 160, and a second video provision unit 170. Further, the generation unit 140 includes a coordinate transform unit 141, a second video generation unit 142, a positional relationship calculation unit 143, and a display position correction unit 144.

The first video acquisition unit 110 is designed to acquire the first video image 10. More specifically, the first video acquisition unit 110 sequentially acquires the respective frames of the first video image 10 selected by the editing device 300. The first video acquisition unit 110 may acquire the first video image 10 by receiving the first video image 10 from the editing device 300, or may acquire the first video image 10 received by some other component from the editing device 300. The first video acquisition unit 110 provides the acquired first video image 10 to the viewpoint information acquisition unit 120 and the delay synchronization unit 150.

The related information acquisition unit 130 is designed to acquire the related information about the first video image 10. More specifically, the related information acquisition unit 130 sequentially acquires the related information generated by the related information generation device 500. The related information acquisition unit 130 may acquire the related information by receiving the related information from the related information generation device 500, or may acquire the related information received by some other component from the related information generation device 500. The related information acquisition unit 130 provides the acquired related information to the viewpoint information acquisition unit 120 and the generation unit 140.

The viewpoint information acquisition unit 120 is designed to acquire information regarding the viewpoint from which the first video image 10 was captured. More specifically, the viewpoint information acquisition unit 120 determines the viewpoint from which the first video image 10 was captured, by analyzing the first video image 10 using information regarding the venue (such as the shape of the ground, the shape of the stadium, or the locations of the video cameras provided in the stadium, in the example of a soccer match live), the information being included in the related information.

For example, the viewpoint information acquisition unit 120 determines the viewpoint from which the first video image 10 was captured, by analyzing the first video image 10 using information regarding the “frame determined depending on the captured target in the first video image 10” (this frame will be hereinafter also referred to simply as the “frame”), the information being included in the related information. The frame is the white lines on the ground in the example of a soccer match live (in other words, the shape of the ground), and therefore, its contents of course change with the captured target in the first video image 10. For example, when the captured target in the first video image 10 is a basketball game, the frame can be the white lines on the court and the hoops. When the captured target in the first video image 10 is a car race, the frame can be the white lines on both sides of the course. When the captured target in the first video image 10 is a concert or a play, the frame can indicate a stage. The viewpoint information acquisition unit 120 recognizes the shape of the ground from the related information, and compares the shape with the white lines of the ground appearing in the first video image 10, to identify (acquire) the viewpoint from which the first video image 10 was captured. Using the white lines (the frame) on the ground, the viewpoint information acquisition unit 120 can more easily identify the viewpoint from which the first video image 10 was captured. By this method, the viewpoint information acquisition unit 120 can acquire not only the viewpoint from which the first video image 10 was captured, but also various kinds of information related to imaging, such as the angle and the magnification at which the first video image 10 was captured. The viewpoint information acquisition unit 120 provides information regarding the acquired viewpoint (alternatively, the information may include information about the angle, the magnification, or the like) to the generation unit 140.

Note that the method by which the viewpoint information acquisition unit 120 acquires the information regarding the viewpoint is not limited to the above method. For example, when the information regarding the viewpoint from which the first video image 10 was captured is included in the related information or is added as metadata to the first video image 10, the viewpoint information acquisition unit 120 may acquire the information regarding the viewpoint from the related information or the first video image 10. Further, when any frame is not included in the first video image 10 (such as a case where the first video image 10 is a video image showing players and audience seats in an enlarged manner, or is a replay video image, for example), when the viewpoint information acquisition unit 120 fails to acquire the information regarding the viewpoint, the viewpoint information acquisition unit 120 provides information indicating the failure to the generation unit 140 (this information will be hereinafter referred to as the “failed acquisition information”).

The generation unit 140 is designed to generate the second video image 20 that is associated with the first video image 10 and is interlocked with the first video image 10, using the information about the viewpoint and the related information. The generation unit 140 generates each frame of the second video image 20 with the respective components described later, and provides the frames to the second video provision unit 170. The generation unit 140 also provides information regarding the time required for generating the second video image 20, to the delay synchronization unit 150. Thus, the delay synchronization unit 150 can compensate for the delay caused at the time of the generation of the second video image 20, and synchronize the display timings of the first video image 10 and the second video image 20 with each other.

The coordinate transform unit 141 is designed to perform coordinate transform on the related information, on the basis of the viewpoint from which the first video image 10 was captured. For example, the coordinate transform unit 141 performs coordinate transform on information regarding the venue (such as the shape of the ground, the shape of the stadium, or the locations of video cameras placed in the stadium, in the example of a soccer match live), information regarding people (such as the players' locations or postures, in the example of a soccer match live), information regarding objects (such as the location of the soccer ball, or the locations of the goalposts, in the example of a soccer match live), or information regarding results of analysis of these pieces of information (such as the location of an offside line, a track of movement of a player or the ball, or a result of prediction of movement, in the example of a soccer match live), on the basis of the viewpoint from which the first video image 10 was captured. These pieces of information are included in the related information. The coordinate transform unit 141 then outputs the locations, the shapes, or the like based on the viewpoint. When the related information is not synchronized with the respective frames of the first video image 10 while the related information is preferably synchronized with the respective frames of the first video image 10 as described above, the coordinate transform unit 141 uses, in the above process, the related information acquired at the time closest to the process target frame of the first video image 10. The coordinate transform unit 141 provides the processed related information to the second video generation unit 142. Note that, when information such as the magnification at the time when the first video image 10 was captured is provided from the viewpoint information acquisition unit 120, the coordinate transform unit 141 may also perform a magnification change or the like, using these pieces of information. Further, when the failed acquisition information is provided from the viewpoint information acquisition unit 120 (in other words, when the acquisition of the information regarding the viewpoint has failed), the coordinate transform unit 141 skips the coordinate transform described above.

The second video generation unit 142 is designed to generate the second video image 20, using the related information subjected to the coordinate transform. More specifically, the second video generation unit 142 generates the second video image 20 by generating a video image corresponding to the related information subjected to the coordinate transform. The “video image corresponding to the related information” shows a target (an object) displayed as the second video image 20, and is the video image 21 corresponding to a player or the video image 22 corresponding to the ground in the example shown in FIG. 1. It goes without saying that the contents of the “video image corresponding to the related information” changes with the related information. For example, information such as a player's name, uniform number, and position included in the related information may be generated as the second video image 20, and be displayed so as to be superimposed on a video image of the player. The second video generation unit 142 may also control the mode of the second video image 20 so that the viewer can intuitively recognize the second video image 20. For example, the second video generation unit 142 may change the color of the second video image 20 to a color similar to the color of the target (such as changing the color of the video image of the player as the second video image 20 to the same color as that of the uniform actually worn by the player, for example), simplify or deform the target as the second video image 20 (such as turning a human figure in which the player is simplified, into the second video image 20, for example), emphasize the contour of the second video image 20, make the second video image 20 blink, or change the size of the second video image 20 in accordance with the height of the target (such as the height of the player, for example) or the distance to the target. The second video generation unit 142 generates the video image corresponding to the related information, on the basis of the related information subjected to the coordinate transform (or may acquire the video image, when the video image is included in the related information). The second video generation unit 142 then provides the generated second video image 20 to the display position correction unit 144. Note that it can be said that the generation unit 140 generates the second video image 20 by transforming the video image corresponding to the related information into a video image from the viewpoint from which the first video image 10 was captured, through the above described processes performed by the coordinate transform unit 141 and the second video generation unit 142.

With this arrangement, even if the viewpoint (camera angle) from which the first video image 10 was captured is not changed, the viewer can intuitively recognize the information outside the field of view of the camera in real time. Accordingly, even when the first video image 10 is an enlarged video image of an object, for example, the viewer can intuitively recognize the location of the object in the venue (the location of a player on the ground, for example), the situation of the entire venue, and the like. The second video generation unit 142 can also make the first video image 10 and the second video image 20 appear to be joined to each other by the process described above, and thus, can give the viewer the impression that the display screen has become larger. Further, as the related information includes information regarding various analysis results (such as the location of an offside line, a track of movement of a player or the ball, or a result of prediction of movement in the example of a soccer match live) as described above, the second video generation unit 142 generates the second video image 20 using these pieces of information, and thus, can provide the viewer with information that is difficult to see from the first video image 10, such as the location of an offside line or a track of movement of a player or the ball.

Note that, when the failed acquisition information is provided from the viewpoint information acquisition unit 120 (in other words, when the acquisition of the information regarding the viewpoint has failed), the second video generation unit 142 generates a substitute second video image 20. For example, when the acquisition of the information regarding the viewpoint has failed due to a reason that the first video image 10 was switched to a video image showing a player and audience seats in an enlarged manner, or to a replay video image or the like, the second video generation unit 142 may generate a video image showing the entire venue as a substitute second video image 20. As such a substitute second video image 20 is generated and displayed, the viewer can easily recognize the state of the entire venue, even if the first video image 10 is switched to a video image showing a player or audience seats in an enlarged manner, or to a replay video image, for example. Note that the contents of the substitute second video image 20 are not limited to any particular contents. Of course, the second video generation unit 142 may skip generation of the second video image 20, without generating any substitute second video image 20, or may continue to generate the second video image 20 from the viewpoint obtained at the point of time when the viewpoint was identified last time (in other words, immediately before the first video image 10 was switched).

The positional relationship calculation unit 143 is designed to calculate the positional relationship between the position at which the first video image 10 is displayed and the position at which the second video image 20 is displayed. In this embodiment, the first video display device 600 that displays the first video image 10 is a television set, and the second video display device 700 that displays the second video image 20 is a projector. Therefore, the positional relationship calculation unit 143 calculates the positional relationship between the position of the display of the television set and the projection position of the projector. The positional relationship calculation unit 143 provides information regarding the positional relationship to the display position correction unit 144. As a result, the display position correction unit 144 in a later stage can appropriately adjust the display position of the second video image 20 on the basis of the positional relationship between the position of the display of the television set and the projection position of the projector. Note that, when the position at which the first video image 10 is displayed and the position at which the second video image 20 is displayed are not in an ideal positional relationship, an instruction for adjusting these positions may be issued. For example, the first video display device 600 or the second video display device 700 may be driven to adjust the display position (for example, the projector includes a camera, and a predetermined marker or the like is added to the television set, so that the projection position of the projector is automatically adjusted on the basis of the position and the size of the marker imaged by the camera of the projector). Alternatively, an ideal display position of the first video display device 600 or the second video display device 700 may be presented to the viewer, and the viewer may adjust the display position of the first video display device 600 or the second video display device 700 on the basis of this presentation (for example, a rectangular marker or the like is projected by the projector, and the viewer adjusts the position of the display of the television set so that the four corners of the marker match the four corners of the display of the television set).

The display position correction unit 144 is designed to correct at least either the position at which the first video image 10 is displayed or the position at which the second video image 20 is displayed, on the basis of the positional relationship between the position at which the first video image 10 is displayed and the position at which the second video image 20 is displayed. Note that, in this embodiment, a case where the display position correction unit 144 corrects only the display position of the second video image 20 is described as an example. With this arrangement, the display position correction unit 144 can display the first video image 10 and the second video image 20 at appropriate positions. Thus, the viewer views the first video image 10 and the second video image 20 as if they were joined to each other, as shown in FIG. 1. The display position correction unit 144 provides the second video image 20 having its display position corrected, to the second video provision unit 170.

The delay synchronization unit 150 is designed to compensate for the delay generated at the time of the generation of the second video image 20, and synchronize the first video image 10 and the second video image 20 with each other. More specifically, when the generation of the second video image 20 took a time equal to or longer than one frame (not necessarily one frame), the delay synchronization unit 150 delays the display timing of the first video image 10 by that amount of time, on the basis of information that is provided from the generation unit 140 and indicates the time required for the generation of the second video image 20. As a result, the first video image 10 and the second video image 20 are displayed at substantially the same timing. The delay synchronization unit 150 provides the first video image 10 synchronized with the second video image 20, to the first video provision unit 160.

The first video provision unit 160 is designed to provide the first video image 10 provided from the delay synchronization unit 150, to the first video display device 600.

The second video provision unit 170 is designed to provide the second video image 20 provided from the generation unit 140, to the second video display device 700.

An example configuration of the information processing device 100 has been described so far. Note that the configuration described above with reference to FIG. 3 is merely an example, and the configuration of the information processing device 100 is not limited to such an example. For example, the information processing device 100 do not necessarily include all of the components shown in FIG. 3, or may further include a component not shown in FIG. 3. Further, the configuration of the information processing device 100 can be flexibly modified depending on specifications and operations.

(1.2. Example Process Flow)

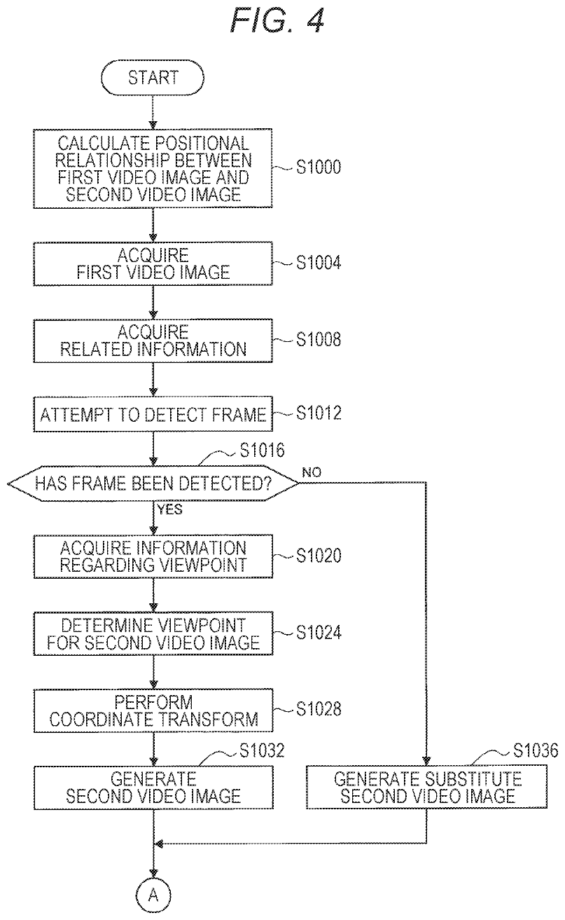

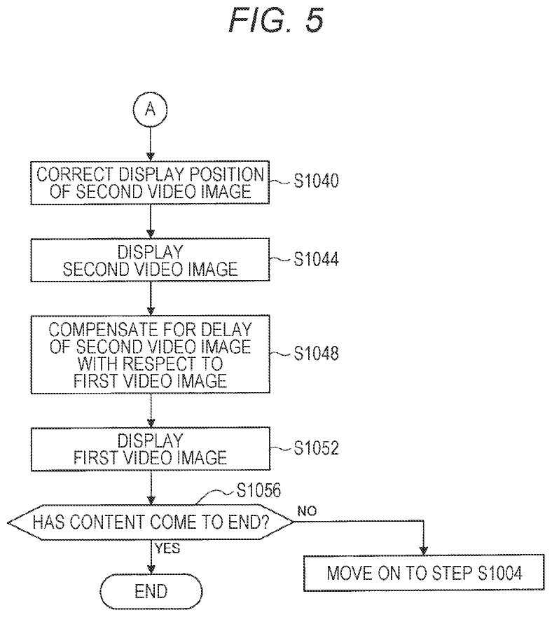

An example configuration according to the first embodiment has been described above. Next, an example process flow in the information processing device 100 according to the first embodiment is described, with reference to FIGS. 4 and 5.

FIGS. 4 and 5 are flowcharts showing an example process flow in the information processing device 100 according to the first embodiment. In step S1000, the positional relationship calculation unit 143 calculates the positional relationship between the position at which the first video image 10 is displayed and the position at which the second video image 20 is displayed. For example, the positional relationship calculation unit 143 calculates the positional relationship between the position of the display of the television set and the projection position of the projector. The display position of the first video display device 600 or the second video display device 700 is then adjusted as appropriate, on the basis of the positional relationship.

In step S1004, the first video acquisition unit 110 acquires the first video image 10. More specifically, the first video acquisition unit 110 sequentially acquires the respective frames of the first video image 10 selected by the editing device 300. In step S1008, the related information acquisition unit 130 acquires the related information about the first video image 10. More specifically, the related information acquisition unit 130 sequentially acquires the related information generated by the related information generation device 500.

In step S1012, the viewpoint information acquisition unit 120 attempts to detect a frame by analyzing the first video image 10. More specifically, the viewpoint information acquisition unit 120 attempts to detect the white lines on the ground appearing in the first video image 10, by analyzing the first video image 10.

If a frame is detected (step S1016/Yes), the viewpoint information acquisition unit 120 in step S1020 acquires information regarding the viewpoint on the basis of the frame. More specifically, the viewpoint information acquisition unit 120 recognizes the shape of the ground from the related information, and compares the shape with the white lines (frame) of the ground appearing in the first video image 10, to identify (acquire) the viewpoint from which the first video image 10 was captured.

In step S1024, the coordinate transform unit 141 determines the viewpoint for the second video image 20. The coordinate transform unit 141 basically sets a viewpoint substantially the same as the viewpoint from which the first video image 10 was captured, as the viewpoint for the second video image 20. However, the coordinate transform unit 141 may adjust the viewpoint for the second video image 20 as appropriate, when various conditions, such as the second video image 20 being larger than a predetermined size (or being too large) with the viewpoint, or the second video image 20 being smaller than a predetermined size (or being too small) with the viewpoint, are satisfied.

In step S1028, the coordinate transform unit 141 performs coordinate transform on the related information. More specifically, the coordinate transform unit 141 performs coordinate transform on information regarding the venue (such as the shape of the ground, the shape of the stadium, or the locations of video cameras placed in the stadium, in the example of a soccer match live), information regarding people (such as the players' locations or postures, in the example of a soccer match live), information regarding objects (such as the location of the soccer ball, or the locations of the goalposts, in the example of a soccer match live), or information regarding results of analysis of these pieces of information (such as the location of an offside line, a track of movement of a player or the ball, or a result of prediction of movement, in the example of a soccer match live), on the basis of the viewpoint from which the first video image 10 was captured. These pieces of information are included in the related information. The coordinate transform unit 141 then outputs the locations, the shapes, or the like based on the viewpoint.

In step S1032, the second video generation unit 142 generates the second video image 20, using the related information subjected to the coordinate transform. More specifically, the second video generation unit 142 generates the second video image 20 by generating a video image (the video image 21 corresponding to a player or the video image 22 corresponding to the ground shown in FIG. 1 in the example of a soccer match live) corresponding to the related information subjected to the coordinate transform.

If any frame is not detected in step S1016 (step S1016/No), the second video generation unit 142 generates a substitute second video image 20 in step S1036. For example, when the detection of a frame has failed due to a reason that the first video image 10 was switched to a video image showing a player and audience seats in an enlarged manner, or to a replay video image, the second video generation unit 142 may generate a video image showing the entire venue or the like as a substitute second video image 20.

In step S1040, the display position correction unit 144 corrects the display position of the second video image 20. More specifically, the display position correction unit 144 corrects the display position of the second video image 20, on the basis of the positional relationship between the display position of the first video image 10 and the display position of the second video image 20, which has been calculated by the positional relationship calculation unit 143.

In step S1044, the second video display device 700 displays the second video image 20. More specifically, the second video provision unit 170 provides the second video image 20 subjected to the display position correction, to the second video display device 700 (the projector in the example shown in FIG. 1), and the second video display device 700 then displays (projects) the second video image 20.

In step S1048, the delay synchronization unit 150 compensates for the delay of the second video image 20 with respect to the first video image 10, and synchronizes the first video image 10 and the second video image 20 with each other. More specifically, when the generation of the second video image 20 took a time equal to or longer than one frame (not necessarily one frame), the delay synchronization unit 150 delays the display timing of the first video image 10 by that amount of time, on the basis of information that is provided from the generation unit 140 and indicates the time required for the generation of the second video image 20.

In step S1052, the first video display device 600 displays the first video image 10. More specifically, the first video provision unit 160 provides the first video image 10 subjected to the delay compensation, to the first video display device 600 (the television set in the example shown in FIG. 1), and the first video display device 600 then displays the first video image 10.

If the content being provided to the viewer has come to an end (step S1056/Yes), the series of processes also end. If the content being provided to the viewer has not ended (step S1056/No), the process moves on to step S1004, and the processes in steps S1004 to S1052 are repeated.

Note that the respective steps in the flowcharts shown in FIGS. 4 and 5 are not necessarily carried out in chronological order according to the order described above. That is, the respective steps in the flowcharts may be carried out in different order from the order described above, or may be carried out in parallel (the same applies to the flowcharts described below).

### 2. Second Embodiment

The first embodiment according to the present disclosure has been described above. Next, a second embodiment according to the present disclosure is described.

In the second embodiment according to the present disclosure, the second video image 20 is displayed by a transmissive head-mounted display worn by the viewer (in other words, the second video display device 700 is a transmissive head-mounted display). The transmissive head-mounted display can provide the viewer with augmented reality (AR), by displaying the second video image 20. The first video image 10 is displayed on a television set or the like as in the first embodiment.

An example configuration according to the second embodiment is described. The position and the posture of the transmissive head-mounted display change from moment to moment, depending on the position and the posture of the viewer. That is, the positional relationship between the position at which the first video image 10 is displayed and the position at which the second video image 20 is displayed changes with the position and the posture (in other words, the viewpoint) of the viewer. Therefore, the positional relationship calculation unit 143 according to the second embodiment calculates the positional relationship between the position at which the first video image 10 is displayed and the position at which the second video image 20 is displayed as needed, and provides information regarding the positional relationship to the display position correction unit 144. More specifically, the positional relationship calculation unit 143 calculates the position and the posture of the transmissive head-mounted display by analyzing sensor data of various sensors (such as a location sensor, a gyroscope sensor, or an image sensor, for example) mounted on the transmissive head-mounted display. On the basis of the position and the posture, the positional relationship calculation unit 143 then calculates the positional relationship between the position at which the first video image 10 is displayed and the position at which the second video image 20 is displayed as needed, and provides information regarding the positional relationship to the display position correction unit 144. As a result, the display position correction unit 144 can adjust the display position of the first video image 10 or the second video image 20, in accordance with the position and the posture of the transmissive head-mounted display that change from moment to moment. As for the other aspects of the example configurations, the example configuration of the information processing system can be similar to that shown in FIG. 2 (an example configuration of the information processing system according to the first embodiment), and the example configuration of the information processing device 100 can be similar to that shown in FIG. 3 (an example configuration of the information processing device 100 according to the first embodiment). Therefore, explanation of them is not made herein.

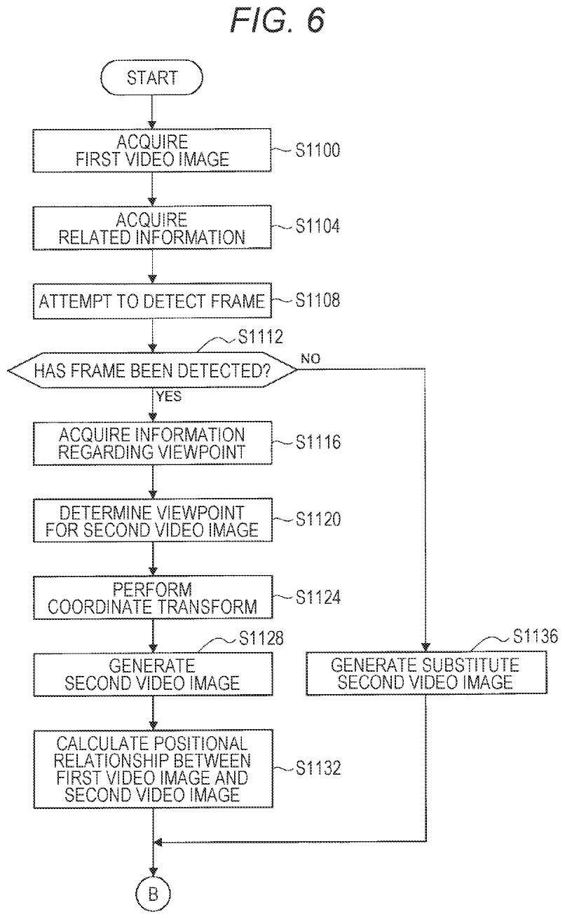

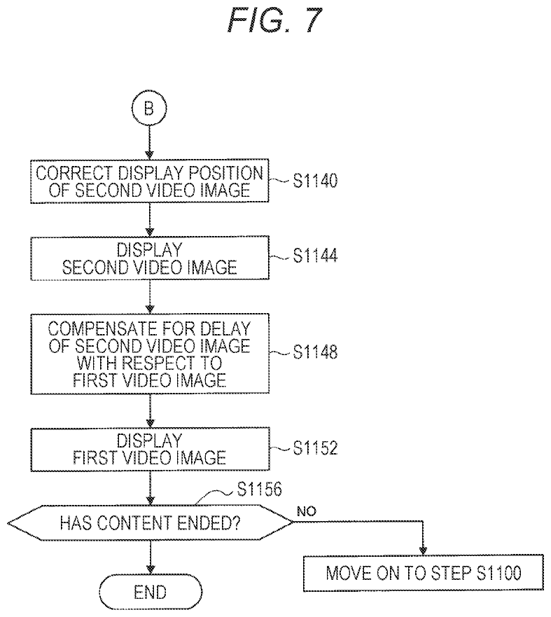

Referring now to FIGS. 6 and 7, an example process flow in the information processing device 100 according to the second embodiment is described. FIGS. 6 and 7 are flowcharts showing an example process flow in the information processing device 100 according to the second embodiment. Comparing FIGS. 6 and 7 with FIGS. 4 and 5 (an example process flow in the information processing device 100 according to the first embodiment) makes it apparent that, in the example process flow in the information processing device 100 according to the second embodiment, the positional relationship calculation unit 143 in step S1132 in FIG. 6 calculates the positional relationship between the position at which the first video image 10 is displayed and the position at which the second video image 20 is displayed. In other words, immediately before correction of the display position of the second video image 20 (step S1140), the positional relationship between the display position of the first video image 10 and the display position of the second video image 20 is calculated. As a result, even if the position and the posture of the transmissive head-mounted display (the second video display device 700) change depending on the position and the posture of the viewer, the information processing device 100 can appropriately cope with the change, and cause the second video image 20 to be displayed at an appropriate position. The other processes can be similar to those in FIGS. 4 and 5 (an example process flow in the information processing device 100 according to the first embodiment), and therefore, explanation of them is not made herein.

The second embodiment can achieve effects similar to those of the first embodiment. More specifically, as the second video image 20 is displayed on the transmissive head-mounted display (the lens portion of a device in the form of eyeglasses, for example), the viewer can intuitively recognize the information outside the field of view of the camera in real time, even if the viewpoint (camera angle) from which the first video image 10 was captured is not changed. In addition to that, in the second embodiment, the second video image 20 is provided to each viewer. Accordingly, even when a plurality of viewers is viewing the first video image 10 from different positions from one another, a second video image 20 suitable for each viewer is provided (in other words, the second video image 20 is optimized for each viewer).

### 3. Third Embodiment

The second embodiment according to the present disclosure has been described above. Next, a third embodiment according to the present disclosure is described.

In the third embodiment according to the present disclosure, the first video image 10 and the second video image 20 are combined to generate a composite video image, and the composite video image is displayed by a non-transmissive head-mounted display. The information processing device 100 may generate a video image forming a virtual space as the composite video image, for example, to provide virtual reality (VR) to the viewer wearing the non-transmissive head-mounted display. For example, the composite video image may be a video image showing how a virtual second video display device 700 (a projector, for example) projects the second video image 20 onto a virtual first video display device 600 (a television set, for example) that displays the first video image 10. The viewable range for the viewer then changes depending on the position and the posture of the non-transmissive head-mounted display. Note that the composite video image may include a virtual object or the like (such as a wall or furniture, for example) serving as the background, in addition to the virtual first video display device 600 and the virtual second video display device 700. This makes it easier for the viewer to be immersed in the virtual space. Further, the video image to be provided to the viewer is not necessarily a video image related to VR.

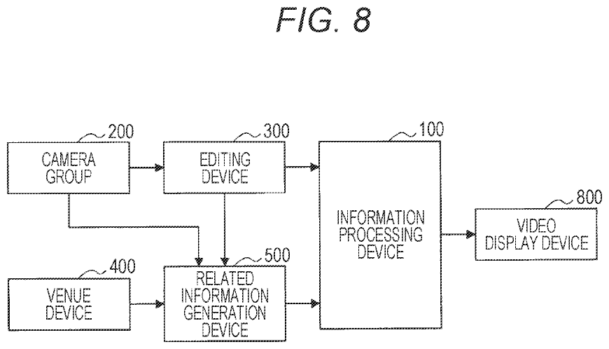

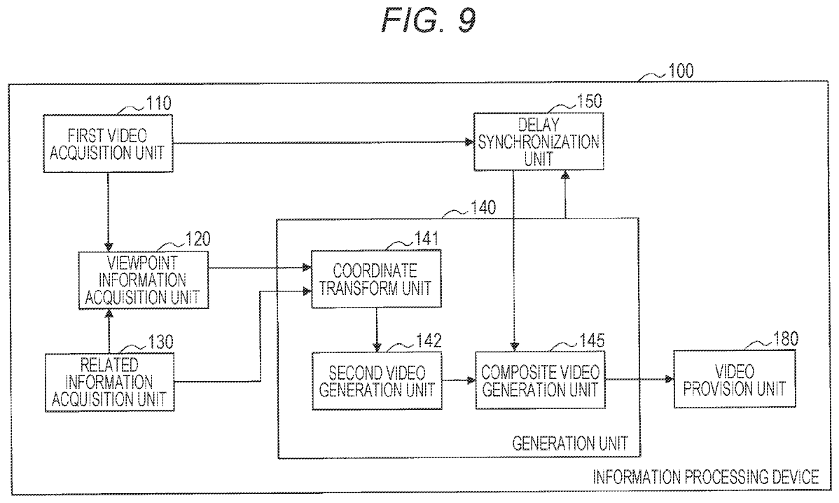

Referring now to FIGS. 8 and 9, an example configuration according to the third embodiment is described. FIG. 8 is a block diagram showing an example configuration of an information processing system according to the third embodiment. As can be seen from a comparison between FIG. 8 and FIG. 2 (an example configuration of the information processing system according to the first embodiment), a video display device 800 is provided in place of the first video display device 600 and the second video display device 700 according to the first embodiment.

The information processing device 100 generates a composite video image by combining the first video image 10 and the second video image 20, and provides the composite video image to the video display device 800. The video display device 800 then displays the composite video image, to present the composite video image to the viewer. The video display device 800 according to this embodiment is a non-transmissive head-mounted display as described above. Note that the video display device 800 is not necessarily a non-transmissive head-mounted display.

FIG. 9 is a block diagram showing an example configuration of the information processing device 100 according to the third embodiment. As can be seen from a comparison between FIG. 9 and FIG. 3 (an example configuration of the information processing device 100 according to the first embodiment), the positional relationship calculation unit 143 and the display position correction unit 144 according to the first embodiment are replaced with a composite video generation unit 145 that is newly provided. Further, a video provision unit 180 is provided in place of the first video provision unit 160 and the second video provision unit 170 according to the first embodiment.

The composite video generation unit 145 is designed to generate a composite video image by combining the first video image 10 acquired by the first video acquisition unit 110 and the second video image 20 generated by the second video generation unit 142. In this embodiment, the delay synchronization unit 150 also compensates for the delay generated at the time of the generation of the second video image 20. More specifically, when the generation of the second video image 20 took a time equal to or longer than one frame (not necessarily one frame), the delay synchronization unit 150 delays the provision timing of the first video image 10 by that amount of time, on the basis of information that is provided from the generation unit 140 and indicates the time required for the generation of the second video image 20. As a result, the composite video generation unit 145 can generate a composite video image, using the first video image 10 and the second video image 20 that are synchronized with each other. The composite video generation unit 145 provides the generated composite video image to the video provision unit 180. The video provision unit 180 is designed to provide the composite video image provided from the composite video generation unit 145, to the video display device 800. After that, the video display device 800 displays the composite video image. As for the other aspects of the example configurations, the example configuration of the information processing system can be similar to that shown in FIG. 2 (an example configuration of the information processing system according to the first embodiment), and the example configuration of the information processing device 100 can be similar to that shown in FIG. 3 (an example configuration of the information processing device 100 according to the first embodiment). Therefore, explanation of them is not made herein.

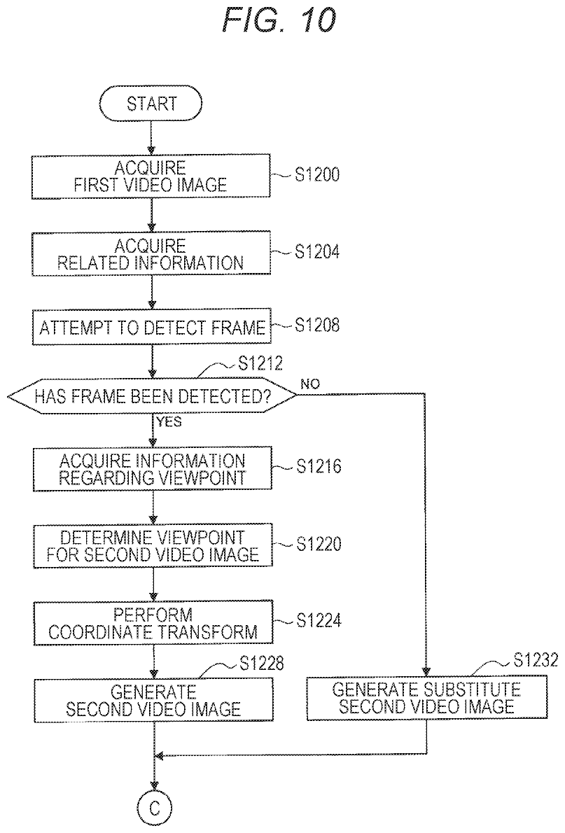

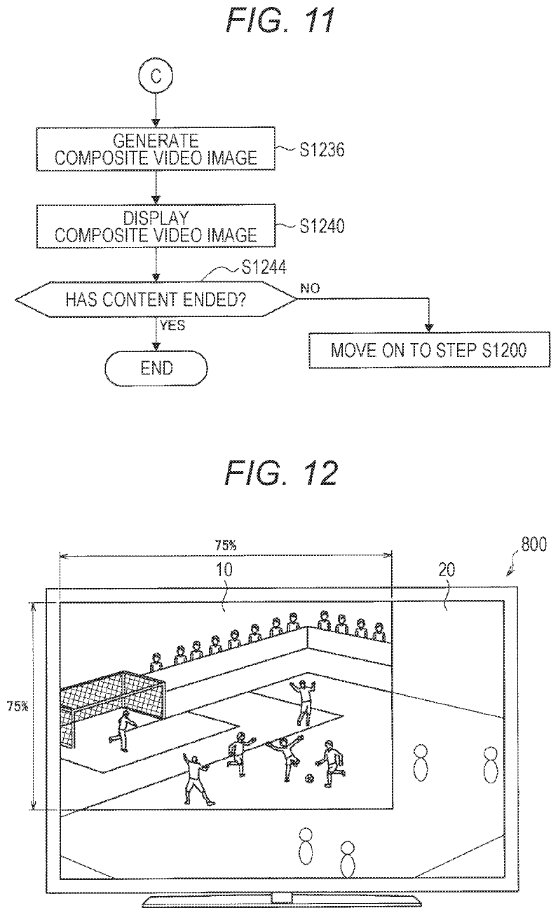

Referring now to FIGS. 10 and 11, an example process flow in the information processing device 100 according to the third embodiment is described. FIGS. 10 and 11 are flowcharts showing an example process flow in the information processing device 100 according to the third embodiment. Steps S1200 to S1232 are similar to steps S1100 to S1136 in FIGS. 6 and 7 (an example process flow according to the second embodiment), and therefore, explanation of them is not made herein. In step S1236, the composite video generation unit 145 combines the first video image 10 and the second video image 20, to generate a composite video image. At that point of time, the delay generated at the time of generation of the second video image 20 is compensated for by the delay synchronization unit 150. In step S1240, the video display device 800 displays the composite video image. More specifically, the video provision unit 180 provides the composite video image to the video display device 800, and the video display device 800 displays the composite video image.

The third embodiment can also achieve effects similar to those of the first embodiment. More specifically, as the composite video image is generated with the use of not only the first video image 10 but also the second video image 20, the viewer can intuitively recognize the information outside the field of view of the camera in real time, even if the viewpoint (camera angle) from which the first video image 10 was captured is not changed. In addition to that, unlike a case where the first video image 10 and the second video image 20 are displayed separately from each other, the third embodiment does not require correction of the display position of the first video image 10 or the second video image 20. Accordingly, the processes in the information processing device 100 are simplified, and there is no longer a possibility that the display position of the first video image 10 and the display position of the second video image 20 will deviate.

### 4. Fourth Embodiment

The third embodiment according to the present disclosure has been described above. Next, a fourth embodiment according to the present disclosure is described.

In the fourth embodiment according to the present disclosure, the video display device 800 that displays a composite video image is a device (such as a television set or a PC, for example) equipped with a stationary display. Note that the type of the device equipped with a stationary display is not limited to any particular type. The information processing device 100 according to the fourth embodiment generates a composite video image by combining a first video image 10 smaller than the size of the entire display of the video display device 800 and a second video image 20 disposed in a margin portion other than the first video image 10 on the display.

For example, as shown in FIG. 12, the information processing device 100 may generate a composite video image by combining a first video image 10 whose lengths of a vertical side and a horizontal side are 75[%] of the lengths of a vertical side and a horizontal side of the display of the video display device 800, and a second video image 20 disposed in a margin portion other than the first video image 10 on the display. Note that the method for determining the sizes and the shapes of the first video image 10 and the second video image 20 in the composite video image is not limited to the above method.

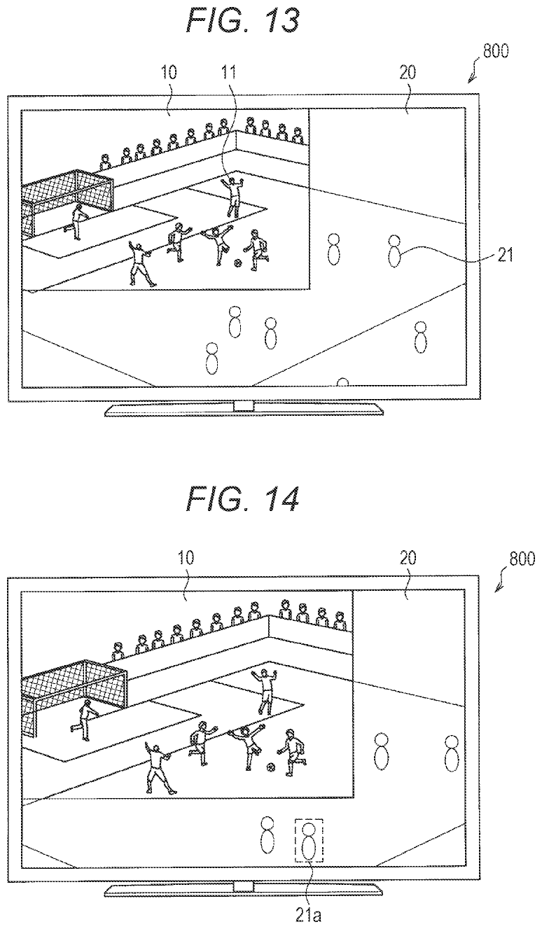

For example, the minimum value of the number of people or the number of objects included in at least either the first video image 10 or the second video image 20 in the composite video image may be set, and the sizes and the shapes of the first video image 10 and the second video image 20 may be determined on the basis of the minimum value. For example, as shown in FIG. 13, a minimum value may be set to at least either the number of video images 11 corresponding to players included in the first video image 10, or the number of video images 21 corresponding to players included in the second video image 20. With this arrangement, the degree of congestion in the display is adjusted.

Further, a person or an object that should be included in at least either the first video image 10 or the second video image 20 in the composite video image may be set, and the sizes and the shapes of the first video image 10 and the second video image 20 may be determined on the basis of the setting. For example, as shown in FIG. 14, a player (a player corresponding to a video image 21a in the example shown in FIG. 14) that should be included in at least either the first video image 10 or the second video image 20 in the composite video image may be set. With this arrangement, information about a person or an object to which attention should be paid is constantly presented to the viewer.

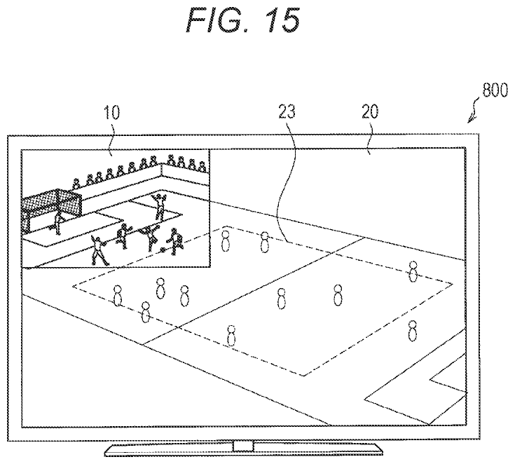

Further, a range (or a region) that should be included in at least either the first video image 10 or the second video image 20 in the composite video image may be set, and the sizes and the shapes of the first video image 10 and the second video image 20 may be determined on the basis of the setting. For example, as shown in FIG. 15, a region (a region corresponding to a video image 23 in the example shown in FIG. 15) that should be included in at least either the first video image 10 or the second video image 20 in the composite video image may be set. With this arrangement, information about a range (or a region) to which attention should be paid is constantly presented to the viewer.

Note that the setting of the conditions (hereinafter referred to as the “video conditions”) to be used for determining the sizes and the shapes of the first video image 10 and the second video image 20 in the composite video image may be performed by a video distributor, or may be performed by the viewer. In the description below, a case where the video conditions are set by the viewer will be described as an example.

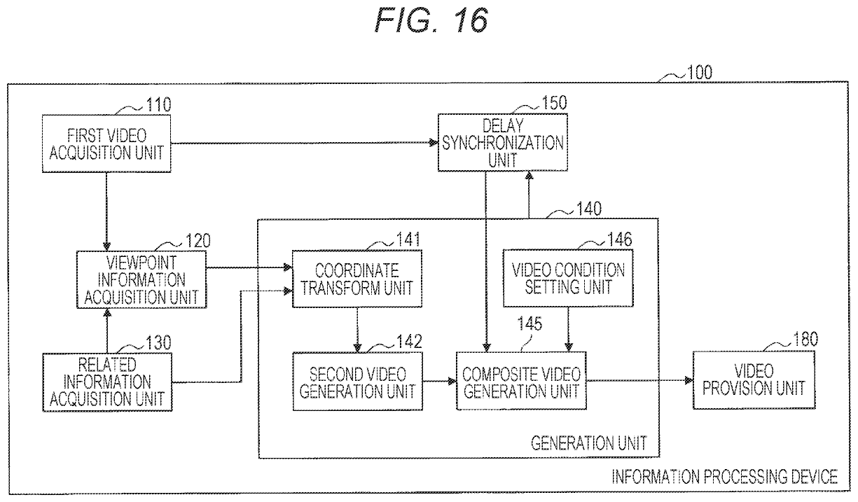

Referring now to FIG. 16, an example configuration according to the fourth embodiment is described. FIG. 16 is a block diagram showing an example configuration of the information processing device 100 according to the fourth embodiment. As can be seen from a comparison between FIG. 16 and FIG. 9 (an example configuration of the information processing device 100 according to the third embodiment), a video condition setting unit 146 is newly provided.

The video condition setting unit 146 is designed to set video conditions, which are at least either the conditions related to the first video image 10 or the conditions related to the second video image 20, on the basis of an input from the viewer. After that, the composite video generation unit 145 generates a composite video image, using the video conditions set by the video condition setting unit 146. As for the other aspects of the example configurations, the example configuration of the information processing system can be similar to that shown in FIG. 8 (an example configuration of the information processing system according to the third embodiment), and the example configuration of the information processing device 100 can be similar to that shown in FIG. 9 (an example configuration of the information processing device 100 according to the third embodiment). Therefore, explanation of them is not made herein.

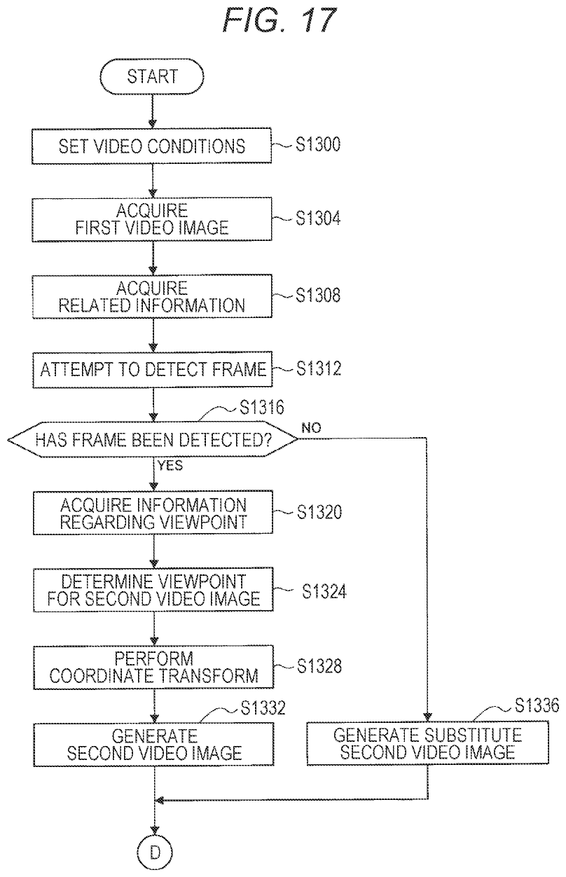

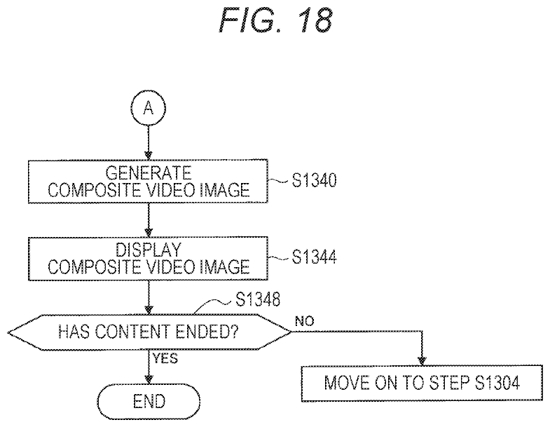

Referring now to FIGS. 17 and 18, an example process flow in the information processing device 100 according to the fourth embodiment is described. FIGS. 17 and 18 are flowcharts showing an example process flow in the information processing device 100 according to the fourth embodiment. In step S1300, the video condition setting unit 146 sets the video conditions on the basis of an input from the viewer. As a result, in a later stage (step S1340), a composite video image is generated on the basis of the video conditions. Steps S1304 to S1348 are similar to steps S1200 to S1244 in FIGS. 10 and 11 (an example process flow according to the third embodiment), and therefore, explanation of them is not made herein.

The fourth embodiment can also achieve effects similar to those of the first embodiment. More specifically, as the composite video image is generated with the use of not only the first video image 10 but also the second video image 20, the viewer can intuitively recognize the information outside the field of view of the camera in real time, even if the viewpoint (camera angle) from which the first video image 10 was captured is not changed. In addition to that, in the fourth embodiment, a device such as a television set or a PC equipped with a stationary display is used, and a device such as a non-transmissive head-mounted display is unnecessary. Thus, the viewer can receive services more easily. Further, the sizes and the shapes of the first video image 10 and the second video image 20 in a composite video image are appropriately controlled in accordance with the video conditions. Further, unlike a case where the first video image 10 and the second video image 20 are displayed separately from each other, this embodiment does not require correction of the display position of the first video image 10 or the second video image 20. Accordingly, the processes in the information processing device 100 are simplified, and there is no longer a possibility that the display position of the first video image 10 and the display position of the second video image 20 will deviate.

### 5. Fifth Embodiment

The fourth embodiment according to the present disclosure has been described above. Next, a fifth embodiment according to the present disclosure is described.

In the fifth embodiment of the present disclosure, a third video image that is different from the first video image 10 and the second video image 20 is further generated, and the first video image 10, the second video image 20, and the third video image are combined to generate a composite video image. The composite video image is then displayed on a device equipped with a stationary display (such as a television set or a PC, for example), or on the video display device 800 including a non-transmissive head-mounted display.

When a PC is used as the video display device 800, for example, the “third video image” includes a video image to be displayed by processing according to a program in the PC. When the viewer is performing some task using the PC, for example, the third video image is a video image that shows the task target. It goes without saying that the contents of the third video image can change depending on the type of the video display device 800, the type of the program executed by the video display device 800, or the like.

The first video image 10, the second video image 20, and the third video image in the composite video image may be displayed in various modes. For example, the region in which the third video image is displayed in the composite video image may be different from the region in which the first video image 10 is displayed and the region in which the second video image 20 is displayed. With this arrangement, the viewer can visually recognize the third video image without being hindered by the first video image 10 and the second video image 20 in the composite video image, and conversely, can visually recognize the first video image 10 and the second video image 20 without being hindered by the third video image.

Alternatively, in the composite video image, the third video image may be displayed while being superimposed on part or all of a semitransparent first video image 10, or on part or all of a semitransparent second video image 20. For example, in the composite video image, the first video image 10 and the third video image may be displayed in different regions from each other, and the entire semitransparent second video image 20 may be superimposed on the third video image. With this arrangement, the first video image 10 and the second video image 20 in the composite video image are displayed larger than those in the display modes described above, and the viewer can also visually recognize the third video image.

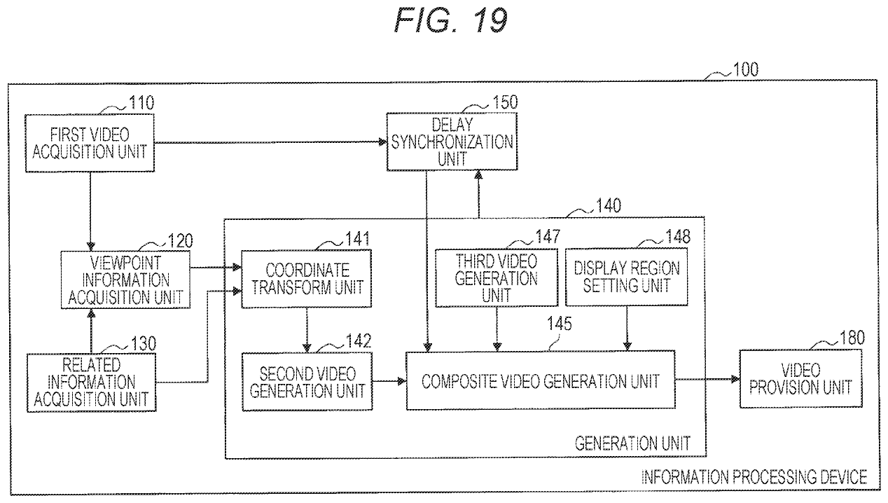

Referring now to FIG. 19, an example configuration according to the fifth embodiment is described. FIG. 19 is a block diagram showing an example configuration of the information processing device 100 according to the fifth embodiment. As can be seen from a comparison between FIG. 19 and FIG. 9 (an example configuration of the information processing device 100 according to the third embodiment), a third video generation unit 147 and a display region setting unit 148 are newly provided.

The third video generation unit 147 is designed to generate the third video image different from the first video image 10 and the second video image 20. For example, when the video display device 800 is a PC, the third video generation unit 147 generates the third video image, on the basis of an input from the viewer to the PC or processing according to a program in the PC. The third video generation unit 147 provides the generated third video image to the composite video generation unit 145.

The display region setting unit 148 is designed to set the display regions of the first video image 10, the second video image 20, and the third video image in a composite video image. That is, the display region setting unit 148 sets in which regions on the display the first video image 10, the second video image 20, and the third video image of the composite video image are to be displayed (in other words, the positions and the sizes of the regions in which the respective video images are to be displayed). The display region setting unit 148 provides the composite video generation unit 145 with information regarding the setting of the display region of the respective video images (this information will be hereinafter referred to as the “region setting information”). Note that the display regions of the respective video images may be set by a video distributor, or may be set by the viewer. Alternatively, the setting of the display regions of the respective video images may be changed during viewing of the content. In the description below, a case where the display regions of the respective video images are set by the viewer will be described as an example. As the third video image is provided from the third video generation unit 147, and the region setting information is provided from the display region setting unit 148, the composite video generation unit 145 can generate the composite video image by combining the first video image 10, the second video image 20, and the third video image.

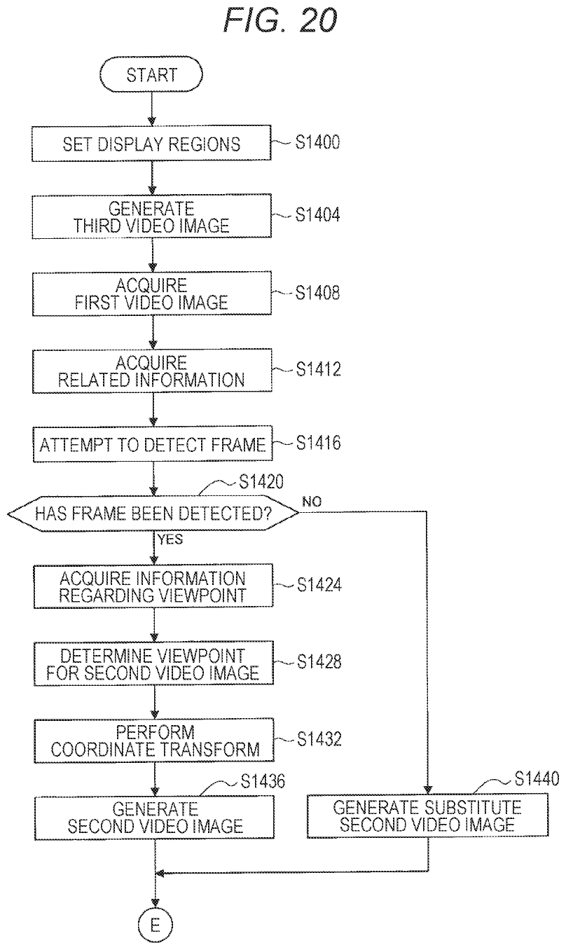

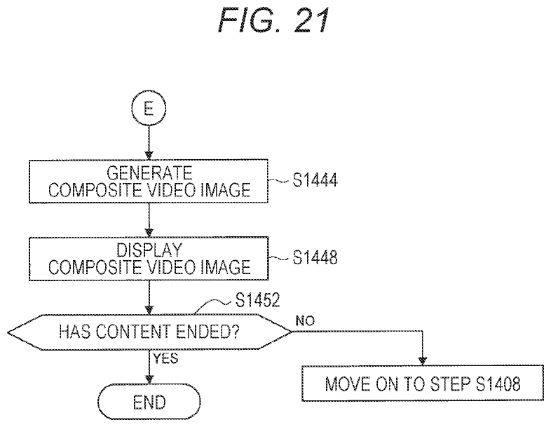

Referring now to FIGS. 20 and 21, an example process flow in the information processing device 100 according to the fifth embodiment is described. FIGS. 20 and 21 are flowcharts showing an example process flow in the information processing device 100 according to the fifth embodiment. In step S1400, the video condition setting unit 146 sets the display regions of the first video image 10, the second video image 20, and the third video image, on the basis of an input from the viewer. As a result, in a later process (step S1444), a composite video image is generated on the basis of the setting of the display regions. In step S1404, the third video generation unit 147 generates the third video image. More specifically, the third video generation unit 147 generates the third video image, on the basis of an input from the viewer to the PC, or processing according to a program in the PC. Steps S1408 to S1452 are similar to steps S1200 to S1244 in FIGS. 10 and 11 (an example process flow according to the third embodiment), and therefore, explanation of them is not made herein.

The fifth embodiment can also achieve effects similar to those of the first embodiment. More specifically, as the composite video image is generated with the use of not only the first video image 10 but also the second video image 20, the viewer can intuitively recognize the information outside the field of view of the camera in real time, even if the viewpoint (camera angle) from which the first video image 10 was captured is not changed. In addition to that, in the fifth embodiment, the composite video image includes the third video image, so that the viewer can view the first video image 10 and the second video image 20, while viewing the third video image and performing tasks, or while viewing content (the third video image) (other than the first video image 10 and the second video image 20).

### 6. Sixth Embodiment

The fifth embodiment according to the present disclosure has been described above. Next, a sixth embodiment according to the present disclosure is described.

The related information according to each of the embodiments described above is information that is generated by the related information generation device 500 using the sensor data acquired by the venue device 400 (various sensors, for example). On the other hand, related information according to the sixth embodiment is a fourth video image that was captured from a viewpoint different from the viewpoint from which the first video image 10 was captured. The “fourth video image” can be a bird's-eye view video image of the entire venue, for example. Note that the fourth video image does not have to be a bird's-eye view video image of the entire venue, but is preferably a video image capturing a range as wide as possible. The information processing device 100 then uses the fourth video image to identify the viewpoint from which the first video image 10 was captured, and uses the fourth video image to generate the second video image 20. Note that not only the fourth video but also information generated using the sensor data acquired by the venue device 400 (various sensors, for example) as in the embodiments described above, and information generated by analyzing the fourth video image may be provided as the related information to the information processing device 100.

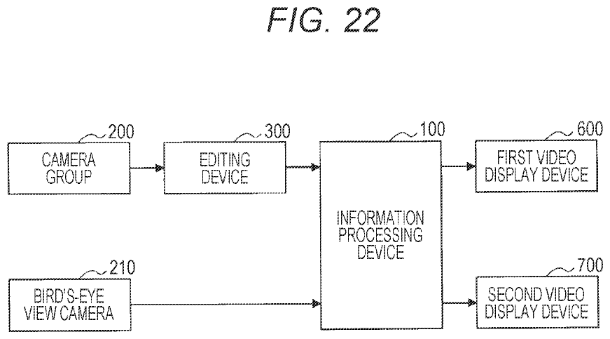

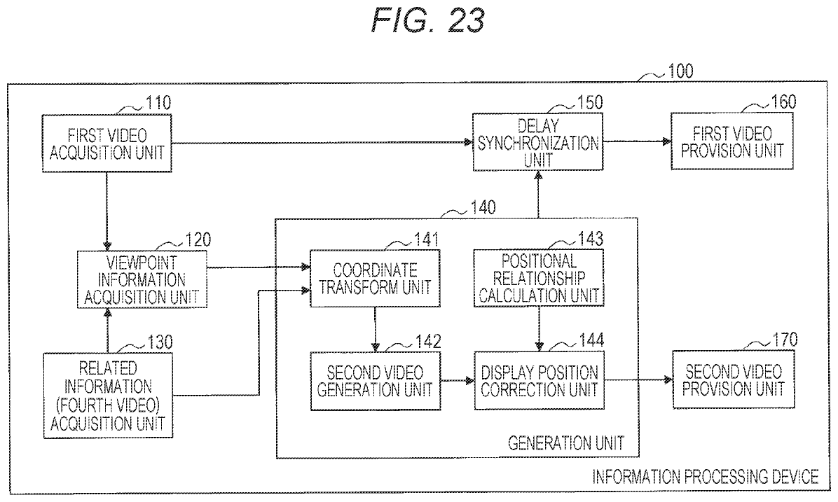

Referring now to FIGS. 22 and 23, an example configuration according to the sixth embodiment is described. FIG. 22 is a block diagram showing an example configuration of an information processing system according to the sixth embodiment. As can be seen from a comparison between FIG. 22 and FIG. 2 (an example configuration of the information processing system according to the first embodiment), a bird's-eye view camera 210 is provided in place of the venue device 400 and the related information generation device 500 according to the first embodiment.

The bird's-eye view camera 210 generates the fourth video image (such as a bird's-eye view video image of the entire venue, for example) captured from a viewpoint different from the viewpoint from which the first video image 10 was captured, and provides the fourth video image to the information processing device 100. Note that the type and the number of the bird's-eye view cameras 210 are not limited to any particular type and number. For example, the fourth video image may be generated using video images captured by a plurality of cameras.

FIG. 23 is a block diagram showing an example configuration of the information processing device 100 according to the sixth embodiment. As can be seen from a comparison between FIG. 23 and FIG. 3 (an example configuration of the information processing device 100 according to the first embodiment), the related information acquisition unit 130 also functions as a fourth video acquisition unit that acquires the fourth video image.

The related information acquisition unit 130 sequentially acquires the respective frames of the fourth video image captured by the bird's-eye view camera 210, as the related information. The related information acquisition unit 130 may acquire the fourth video image by receiving the fourth video image from the bird's-eye view camera 210, or may acquire the fourth video image that some other component has received from the bird's-eye view camera 210. The related information acquisition unit 130 provides the acquired fourth video image to the viewpoint information acquisition unit 120 and the generation unit 140.

The viewpoint information acquisition unit 120 analyzes the fourth video image that is the related information, to recognize information regarding the venue (such as the shape of the ground, the shape of the stadium, or the locations of the video cameras provided in the stadium, in the example of a soccer match live). The viewpoint information acquisition unit 120 then analyzes the first video image 10 using the information regarding the venue, to determine the viewpoint from which the first video image 10 was captured. Note that, instead of recognizing the information regarding the venue by analyzing the fourth video image, the viewpoint information acquisition unit 120 may be separately provided with the information, or may be provided with information regarding a general venue (such as the shape of a general ground, for example). Alternatively, information regarding the viewpoint from which the first video image 10 was captured may be added as metadata to the first video image 10, and the viewpoint information acquisition unit 120 may acquire the information regarding the viewpoint from the first video image 10. On the basis of the viewpoint from which the first video image 10 was captured, the coordinate transform unit 141 performs coordinate transform on the fourth video image captured at substantially the same timing as the first video image 10. The second video generation unit 142 then generates the second video image 20, using the fourth video image subjected to the coordinate transform. For example, the second video generation unit 142 generates the second video image 20 by using the fourth video image subjected to the coordinate transform as the second video image 20 without any change thereto, or by extracting a person, an object, or the like from the fourth video image subjected to the coordinate transform. As for the other aspects of the example configurations, the example configuration of the information processing system can be similar to that shown in FIG. 2 (an example configuration of the information processing system according to the first embodiment), and the example configuration of the information processing device 100 can be similar to that shown in FIG. 3 (an example configuration of the information processing device 100 according to the first embodiment). Therefore, explanation of them is not made herein.

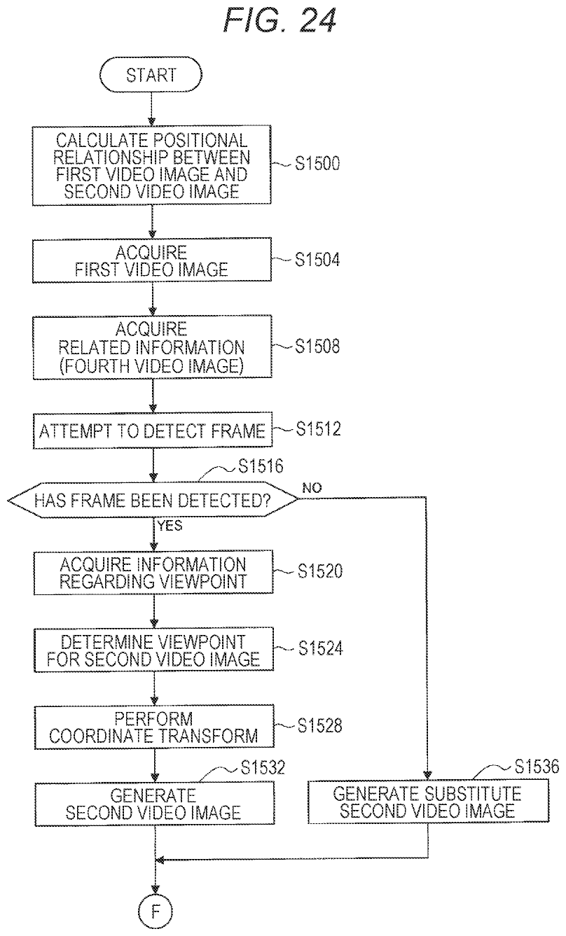

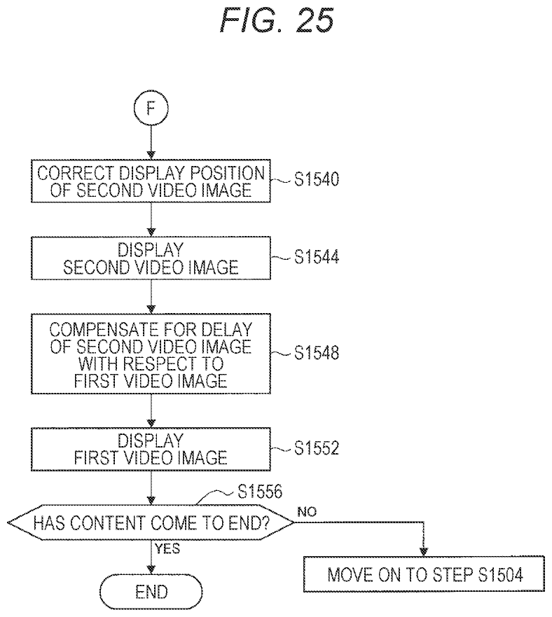

Referring now to FIGS. 24 and 25, an example process flow in the information processing device 100 according to the sixth embodiment is described. FIGS. 24 and 25 are flowcharts showing an example process flow in the information processing device 100 according to the sixth embodiment. In step S1508, the related information acquisition unit 130 acquires the fourth video image as the related information. As a result, in later processes, the information regarding the viewpoint is acquired, and the second video image 20 is generated, with the use of the fourth video image. Steps S1500 to S1556 are similar to steps S1000 to S1056 in FIGS. 4 and 5 (an example process flow according to the first embodiment), and therefore, explanation of them is not made herein.

The sixth embodiment can also achieve effects similar to those of the first embodiment. More specifically, as the second video image 20 is displayed on the transmissive head-mounted display or the like, the viewer can intuitively recognize the information outside the field of view of the camera in real time, even if the viewpoint (camera angle) from which the first video image 10 was captured is not changed. In addition to that, at the site (venue), it is possible to embody the present disclosure simply by providing the bird's-eye view camera 210, without the venue device 400 such as various sensors and the related information generation device 500 that analyzes sensor data or the like. Thus, the load can be reduced. Further, as the information processing device 100 can use the fourth video image as it is to generate the second video image 20, the load on the information processing device 100 can also be reduced. Furthermore, as the information processing device 100 can generate the second video image 20 by extracting a person, an object, or the like from the fourth video image, the realistic feeling in the second video image 20 can be increased.

### 7. Remarks

The sixth embodiment according to the present disclosure has been described above. Next, the measures to be taken when the second video image 20 does not fit in the displayable region of the second video display device 700 are described.

As described above, the second video display device 700 displays the entire venue (ground) as the second video image 20 as shown in FIG. 1, for example, so that the viewer can intuitively recognize the state of the venue even if the viewpoint (camera angle) from which the first video image 10 was captured is not changed. However, when the first video image 10 is an enlarged video image of an object or the like, the second video image 20 might become too large to fit in the displayable region of the second video display device 700. In this case, a partially missing second video image 20 is displayed.

Therefore, when the second video image 20 does not fit in the displayable region of the second video display device 700, the information processing device 100 may not generate any second video image 20 that appears to be joined to the first video image 10 on purpose. The information processing device 100 may then generate the second video image 20 that is a second video image 20 displaying the entire venue (ground) and includes information regarding the region corresponding to the first video image 10 in the second video image 20.

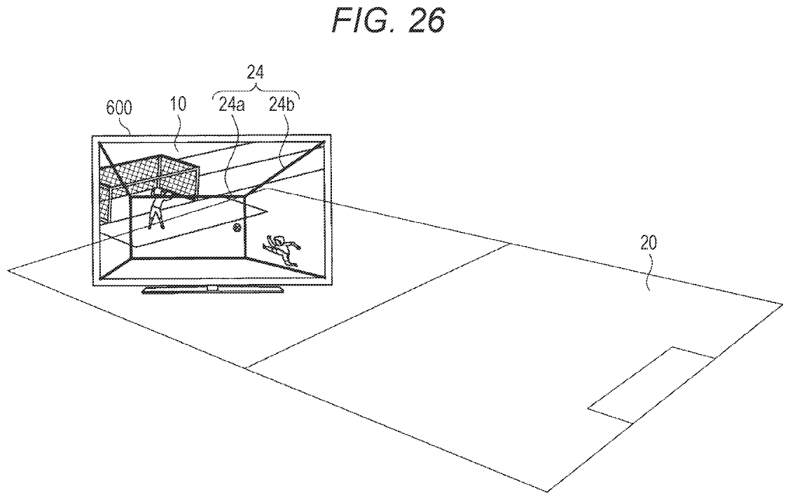

For example, as shown in FIG. 26, the information processing device 100 may not generate the second video image 20 that appears to be joined to the first video image 10 on purpose, but may generate the second video image 20 that is a second video image 20 showing the entire venue (ground) and includes a video image 24 indicating the region corresponding to the first video image 10 in the second video image 20. In the example in FIG. 26, the video image 24 includes a video image 24a of a frame indicating the region corresponding to the first video image 10 in the second video image 20, and a video image 24b of lines connecting the vertexes of the frame and the vertexes of the display of the first video display device 600. With the video image 24, the viewer can intuitively recognize the region corresponding to the first video image 10 in the second video image 20. Note that, in the second video image 20, the information regarding the region corresponding to the first video image 10 is not necessarily the video image 24. For example, the information may be characters or the like indicating the region corresponding to the first video image 10 in the second video image 20.

### 8. Example Hardware Configuration

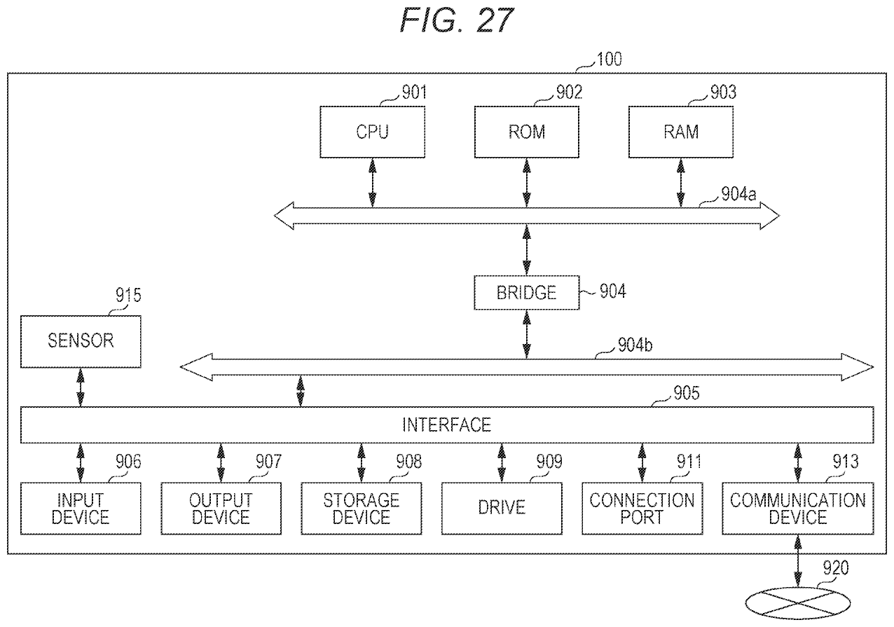

The measures to be taken when the second video image 20 does not fit in the displayable region of the second video display device 700 have been described above. Next, referring to FIG. 27, an example hardware configuration of the information processing device 100 according to each embodiment is described. FIG. 27 is a block diagram showing an example hardware configuration of the information processing device 100 according to each embodiment. Various processes to be performed by the information processing device 100 are realized by cooperation between software and the hardware described below.

As shown in FIG. 27, the information processing device 100 includes a central processing unit (CPU) 901, a read only memory (ROM) 902, a random access memory (RAM) 903, and a host bus 904a. The information processing device 100 also includes a bridge 904, an external bus 904b, an interface 905, an input device 906, an output device 907, a storage device 908, a drive 909, a connection port 911, a communication device 913, and a sensor 915. The information processing device 100 may include a processing circuit such as a DSP or an ASIC, instead of or in addition to the CPU 901.

The CPU 901 functions as an arithmetic processing device and a control device, and controls the overall operation in the information processing device 100, according to various programs. Alternatively, the CPU 901 may be a microprocessor. The ROM 902 stores the programs, the operation parameters, and the like to be used by the CPU 901. The RAM 903 temporarily stores the programs to be used in execution by the CPU 901, parameters that change in the execution as appropriate, and the like. The CPU 901 can embody each component of the information processing device 100.

The CPU 901, the ROM 902, and the RAM 903 are connected to one another by the host bus 904a including a CPU bus or the like. The host bus 904a is connected to the external bus 904b such as a peripheral component interconnect/interface (PCI) bus, via the bridge 904. Note that the host bus 904a, the bridge 904, and the external bus 904b are not necessarily formed separately from one another, but these functions may be incorporated into one bus.

The input device 906 is formed with a device to which information is input by the viewer, such as a mouse, a keyboard, a touch panel, buttons, a microphone, or switches and levers, for example. Also, the input device 906 may be a remote control device that uses infrared rays or other radio waves, or may be an external connection device such as a mobile telephone device or a PDA compatible with operations of the information processing device 100, for example. Further, the input device 906 may include an input control circuit or the like that generates an input signal on the basis of information input by the viewer using the above input means, and outputs the input signal to the CPU 901, for example. By operating this input device 906, the viewer can input various kinds of data or issues a processing operation instruction to the information processing device 100.

The output device 907 is formed with a device capable of visually or auditorily notifying the viewer of acquired information. Examples of such a device include display devices such as a CRT display device, a liquid crystal display device, a plasma display device, an EL display device, and a lamp, sound output devices such as a speaker and a set of headphones, and printer devices.

The storage device 908 is a device for storing data. The storage device 908 is formed with a magnetic storage device such as an HDD, a semiconductor storage device, an optical storage device, or a magneto-optical storage device, for example. The storage device 908 may include a storage medium, a recording device that records data into the storage medium, a reading device that reads data from the storage medium, a deletion device that deletes data recorded in the storage medium, and the like. This storage device 908 stores the programs and various kinds of data to be executed by the CPU 901, various kinds of data acquired from the outside, and the like.

The drive 909 is a reader/writer for a storage medium, and is installed in or externally attached to the information processing device 100. The drive 909 reads information recorded in a removable storage medium such as a mounted magnetic disk, optical disk, magnetooptical disk, or semiconductor memory, and outputs the information to the RAM 903. The drive 909 can also write information into a removable storage medium.

The connection port 911 is an interface connected to an external device, and is a connection port to an external device capable of transmitting data through a universal serial bus (USB) or the like, for example.

The communication device 913 is a communication interface that is formed with a communication device or the like for connecting to a network 920, for example. The communication device 913 is a communication card for wired or wireless local area network (LAN), long term evolution (LTE), Bluetooth (registered trademark), wireless USB (WUSB), or the like, for example. Further, the communication device 913 may also be a router for optical communication, a router for asymmetric digital subscriber line (ADSL), a modem for various communications, or the like. This communication device 913 can transmit and receive signals and the like to and from the Internet and other communication devices, according to a predetermined protocol such as TCP/IP, for example. The communication device 913 may embody the first video acquisition unit 110 or the related information acquisition unit 130 of the information processing device 100.

The sensor 915 includes various kinds of sensors (such as an acceleration sensor, a gyroscope sensor, a geomagnetic sensor, a pressure sensitive sensor, a sound sensor, or a ranging sensor, for example).

Note that the network 920 is a wired or wireless transmission path for information to be transmitted from devices connected to the network 920. For example, the network 920 may include a public network such as the Internet, a telephone network, and a satellite communication network, various kinds of local area networks (LANs) including Ethernet (registered trademark), and wide area networks (WANs). The network 920 may also include a dedicated line network such as an Internet protocol-virtual private network (IP-VPN).

An example hardware configuration capable of realizing the functions of the information processing device 100 has been described above. Each of the components described above may be formed with a general-purpose member, or may be formed with hardware specialized for the function of each component. Accordingly, it is possible to change the hardware configuration to be used, as appropriate, depending on the technical level at the time of carrying out each embodiment.

Note that a computer program for realizing each function of the information processing device 100 as described above can be created and installed into a PC or the like. It is also possible to provide a computer-readable recording medium in which such a computer program is stored. The recording medium includes a magnetic disk, an optical disk, a magnetooptical disk, a flash memory, or the like, for example. Further, the above computer program may be delivered via a network, for example, without the use of any recording medium.

While preferred embodiments of the present disclosure have been described above with reference to the accompanying drawings, the technical scope of the present disclosure is not limited to those examples. It is apparent that those who have ordinary skills in the technical field of the present disclosure can make various changes or modifications within the scope of the technical spirit claimed herein, and it should be understood that those changes or modifications are within the technical scope of the present disclosure.

Furthermore, the effects disclosed in this specification are merely illustrative or exemplary, but are not restrictive. That is, the technology according to the present disclosure may achieve other effects obvious to those skilled in the art from the description in the present specification, in addition to or instead of the effects described above.

Note that the configurations described below are also within the technical scope of the present disclosure.

(1)

An information processing device including:

a viewpoint information acquisition unit that acquires information regarding a viewpoint from which a first video image has been captured;

a related information acquisition unit that acquires related information about the first video image; and

a generation unit that generates a second video image using the information regarding the viewpoint and the related information, the second video image being associated with the first video image and being interlocked with the first video image.

(2)

The information processing device according to (1), in which

the generation unit generates the second video image by transforming a video image corresponding to the related information into a video image from the viewpoint.

(3)

The information processing device according to (2), in which

the first video image and the second video image complement each other with missing information.

(4)

The information processing device according to (3), in which

the first video image or the second video image includes at least part of a frame determined depending on an imaging target in the first video image.

(5)

The information processing device according to any one of (1) to (4), in which

the generation unit includes:

a positional relationship calculation unit that calculates a positional relationship between a position at which the first video image is displayed and a position at which the second video image is displayed; and

a display position correction unit that corrects at least one of the position at which the first video image is displayed or the position at which the second video image is displayed, on the basis of the positional relationship.

(6)

The information processing device according to (5), in which

the second video image is projected toward a display that displays the first video image.

(7)

The information processing device according to (5) or (6), in which

the positional relationship changes depending on a viewpoint of a viewer.

(8)

The information processing device according to (7), in which

the second video image is displayed by a transmissive head-mounted display worn by the viewer.

(9)

The information processing device according to any one of (1) to (4), further including

a first video acquisition unit that acquires the first video image,

in which the generation unit includes a composite video generation unit that generates a composite video image by combining the first video image and the second video image.

(10)

The information processing device according to (9), in which

the composite video image is displayed by a non-transmissive head-mounted display.

(11)

The information processing device according to (9) or (10), in which

the generation unit includes a video condition setting unit that sets at least one of a condition related to the first video image or a condition related to the second video image, and

the composite video generation unit generates the composite video image, using the condition related to the first video image or the condition related to the second video image.

(12)

The information processing device according to any one of (9) to (11), in which

the generation unit further generates a third video image different from the first video image and the second video image, and

the composite video generation unit generates the composite video image by combining the first video image, the second video image, and the third video image.

(13)

The information processing device according to (12), in which

a region in which the third video image is displayed in the composite video image is different from a region in which the first video image is displayed and a region in which the second video image is displayed.

(14)

The information processing device according to (12), in which,

in the composite video image, the third video image is displayed, being superimposed on part or all of a semitransparent one of the first video image, or on part or all of a semitransparent one of the second video image.

(15)

The information processing device according to any one of (1) to (14), in which

the related information is a fourth video image captured from a viewpoint different from the viewpoint from which the first video image has been captured.

(16)

An information processing method implemented by a computer,

the information processing method including:

acquiring information regarding a viewpoint from which a first video image has been captured;

acquiring related information about the first video image; and

generating a second video image using the information regarding the viewpoint and the related information, the second video image being associated with the first video image and being interlocked with the first video image.

(17)

A program for causing a computer to:

acquire information regarding a viewpoint from which a first video image has been captured;

acquire related information about the first video image; and

generate a second video image using the information regarding the viewpoint and the related information, the second video image being associated with the first video image and being interlocked with the first video image.

### REFERENCE SIGNS LIST

10 First video image
20 Second video image
100 Information processing device
110 First video acquisition unit
120 Viewpoint information acquisition unit
130 Related information acquisition unit (fourth video acquisition unit)
140 Generation unit
141 Coordinate transform unit
142 Second video generation unit
143 Positional relationship calculation unit
144 Display position correction unit
145 Composite video generation unit
146 Video condition setting unit
147 Third video generation unit
148 Display region setting unit
150 Delay synchronization unit
160 First video provision unit
170 Second video provision unit
180 Video provision unit
200 Camera group
210 Bird's-eye view camera
300 Editing device
400 Venue device
500 Related information generation device
600 First video display device
700 Second video display device
800 Video display device

1. An information processing device comprising:
a viewpoint information acquisition unit that acquires information regarding a viewpoint from which a first video image has been captured;
a related information acquisition unit that acquires related information about the first video image; and
a generation unit that generates a second video image using the information regarding the viewpoint and the related information, the second video image being associated with the first video image and being interlocked with the first video image.

2. The information processing device according to claim 1, wherein
the generation unit generates the second video image by transforming a video image corresponding to the related information into a video image from the viewpoint.

3. The information processing device according to claim 2, wherein
the first video image and the second video image complement each other with missing information.

4. The information processing device according to claim 3, wherein
the first video image or the second video image includes at least part of a frame determined depending on an imaging target in the first video image.

5. The information processing device according to claim 1, wherein
the generation unit includes:
a positional relationship calculation unit that calculates a positional relationship between a position at which the first video image is displayed and a position at which the second video image is displayed; and
a display position correction unit that corrects at least one of the position at which the first video image is displayed or the position at which the second video image is displayed, on a basis of the positional relationship.

6. The information processing device according to claim 5, wherein
the second video image is projected toward a display that displays the first video image.

7. The information processing device according to claim 5, wherein
the positional relationship changes depending on a viewpoint of a viewer.

8. The information processing device according to claim 7, wherein
the second video image is displayed by a transmissive head-mounted display worn by the viewer.

9. The information processing device according to claim 1, further comprising
a first video acquisition unit that acquires the first video image,
wherein the generation unit includes a composite video generation unit that generates a composite video image by combining the first video image and the second video image.

10. The information processing device according to claim 9, wherein
the composite video image is displayed by a non-transmissive head-mounted display.

11. The information processing device according to claim 9, wherein
the generation unit includes a video condition setting unit that sets at least one of a condition related to the first video image or a condition related to the second video image, and
the composite video generation unit generates the composite video image, using the condition related to the first video image or the condition related to the second video image.

12. The information processing device according to claim 9, wherein
the generation unit further generates a third video image different from the first video image and the second video image, and
the composite video generation unit generates the composite video image by combining the first video image, the second video image, and the third video image.

13. The information processing device according to claim 12, wherein
a region in which the third video image is displayed in the composite video image is different from a region in which the first video image is displayed and a region in which the second video image is displayed.

14. The information processing device according to claim 12, wherein,
in the composite video image, the third video image is displayed while being superimposed on part or all of a semitransparent one of the first video image, or on part or all of a semitransparent one of the second video image.

15. The information processing device according to claim 1, wherein
the related information is a fourth video image captured from a viewpoint different from the viewpoint from which the first video image has been captured.

16. An information processing method implemented by a computer,
the information processing method comprising:
acquiring information regarding a viewpoint from which a first video image has been captured;
acquiring related information about the first video image; and
generating a second video image using the information regarding the viewpoint and the related information, the second video image being associated with the first video image and being interlocked with the first video image.

17. A program for causing a computer to:
acquire information regarding a viewpoint from which a first video image has been captured;
acquire related information about the first video image; and
generate a second video image using the information regarding the viewpoint and the related information, the second video image being associated with the first video image and being interlocked with the first video image.
